(19) United States
(12) Patent Application Publication
(10) Pub. No.: US 2002/0185235 A1
(43) Pub. Date: Dec. 12, 2002

(54) Bead breaking lever (tool)

(76) Inventor: Rino Spaggiari, Viale Saltini (IT)

Correspondence Address: Stephen A. Becker, McDERMOTT, WILL & EMERY, 600 13th Street, N.W., Washington, DC, 20005-3096, US

(21) Appl. No.: 09/884,101

(22) Filed: Jun. 20, 2001

(30) Foreign Application Priority Data
Aug. 31, 2000 (IT) M02000A000181

(51) Int. Cl. B60C 25/04

(52) U.S. Cl. 157/1.3

(57) ABSTRACT

An extractor tool (1) for extracting tire beads includes an extractor head (2) having a handle (3) on one end and a bent extension (4) formed on the other end. The bend extension (4) has a predetermined inclination relative to the longitudinal axis of the main body of the extractor head (4) and forms an upper surface to be in contact with the bead of a tire. A concave surface (5) and a lower surface are formed between the extractor head (2) and the bent extension (4). The lower surface is in contact with the edge (13) of a tire rim (12) during operation. A first short section (6) bounds the bent extension (4) from underneath and connects to a second extensive section (7) by means of a joint (8). The second extensive section (7) has a radius of curvature perceptibly less than the radius of curvature of the concave surface (5).

The object of this invention is a tire bead extractor tool, that is, a tool used as a lever to remove the bead of a tire from its seated position along the edge of the rim on which it is installed.

To be specific, but not exclusive, one useful application is to use it for the extraction of PAX type tire beads.

Devices for extracting traditional tire beads, that is, on which the two beads have the same diameter, have been known for a long time. This is the case for other levers, having their ends formed in various shapes and rounded to permit execution of their own specific function by means of insertion between the traditional bead and the corresponding edge of the rim on which the tire was initially installed.

Such levers have a configuration which does not allow them to be used for extraction of the external bead of PAV tires. In particular, it is extremely difficult to insert the end between the rim edge and the bead in a manner so that the known lever can use the outer edge of the rim as a pivot to raise the bead. In fact, the levers in question, by reason of their configuration, tend to be inexorably pushed outward with considerable force, which must be countered by an adequate and very uncomfortable exertion by the user.

The purpose of this invention is to eliminate the limitations and shortcomings of the known technique.

An advantage of this invention [is] to permit extraction of the beads in a simple manner and with minimum effort by the user; the only effort required is enough to permit rotation of the tool upon the fulcrum constituted by its point of rest upon the rim's outer edge.

These purposes and advantages, as well as others are all obtained by this invention, as characterized by the claims enumerated below.

Further characteristics and advantages of this discovered improvement will appear in the following detailed description of a preferred, but not exclusive application of this invention, shown for purely illustrative, but not limitative purposes, in the accompanying figures, wherein:

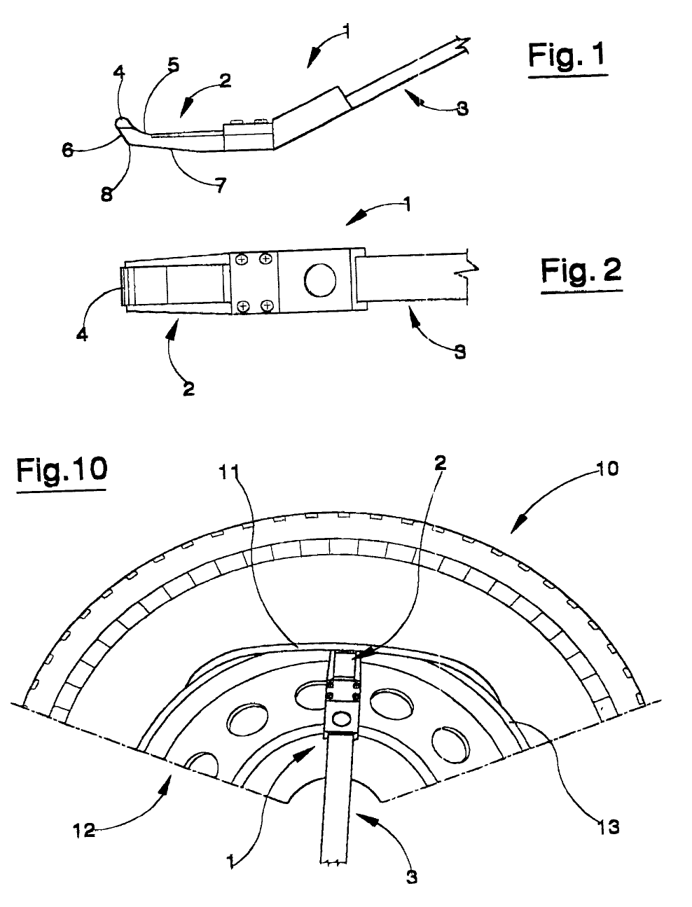

FIG. 1 shows it in a schematic side view;

FIG. 2 shows the schematic of FIG. 1 in a plan view;

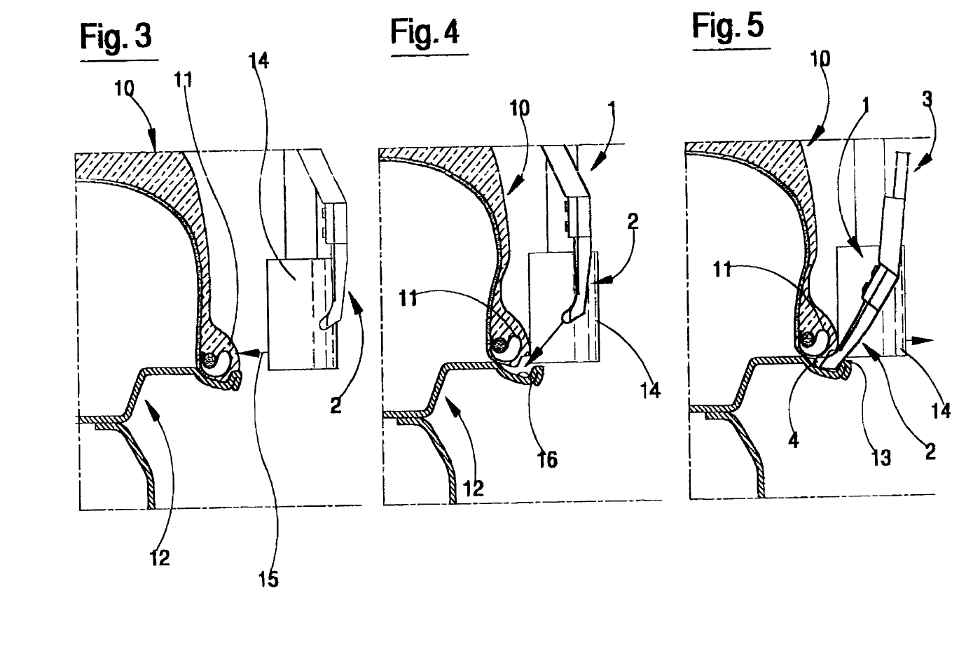

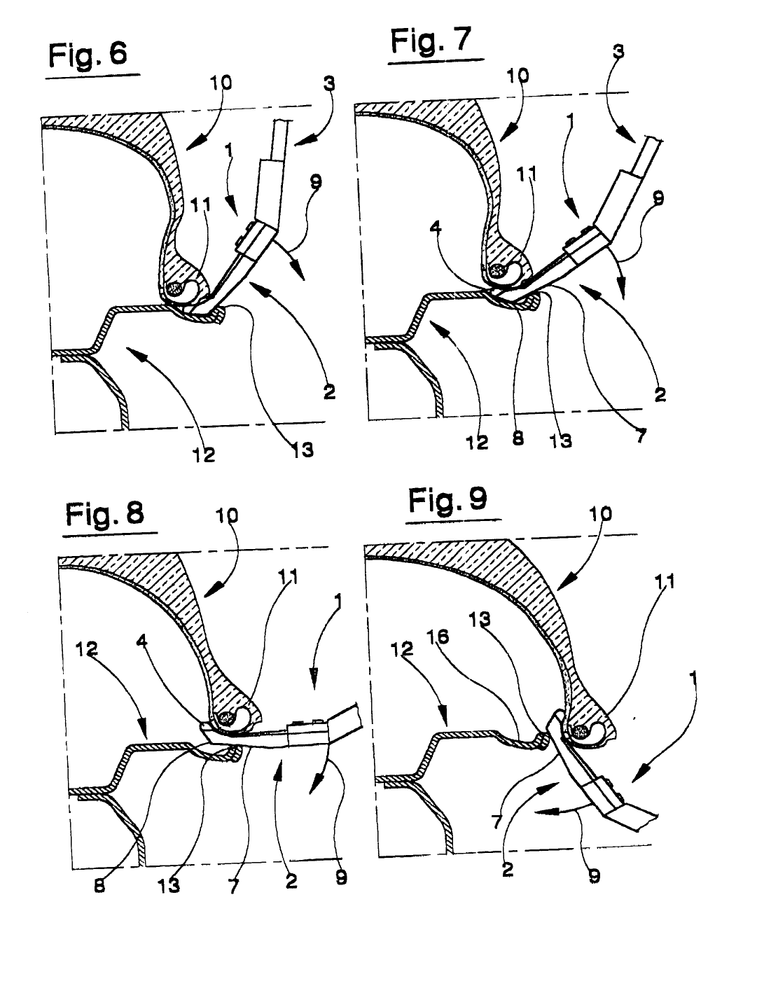

FIGS. 3, 4, 5, 6, 7, 8, 9 in accordance with a radial section, show some operational phases of the tool's use for extracting a tire bead;

FIG. 10 shows, in reduced scale, a right side view of FIG. 9.

With reference to the cited figures, the numeral 1 is used overall to indicate an extractor tool, in particular for the extraction of PAX type tire beads.

It comprises an extractor head 2, affixed by projection to a handle 3, and whose end is shaped with a bent extension 4 having a predetermined inclination relative to the longitudinal axis of the main body of the extractor head 2, so as to generate an upper surface intended to operate in contact with the bead 11 of a tire 10, having a broad concave surface 5 which joins the said bent extension 4 with the body of the extractor head 2.

The extension and curvature of the concave surface 5 are designed as a function of the shape and dimensions of the bead 11 in the proportions which can be ascertained from the accompanying Figures.

The end of the extractor head 2 is also shaped so as to generate a lower surface, which is intended to operate in contact with the edge (outer) 13 of a tire rim 12, which has a first short section of its end 6 which bounds the extension 4 from underneath, and which is connected to a second more extensive section 7 by means of a joint 8 which has a radius of curvature perceptibly less than the radius of curvature of the concave surface 5.

In particular (the axis of) the bent extension 4 subtends an obtuse angle with the main body of the extractor head 2.

The useful lever arm extracting the bead 11 by transmitting a rotation in the direction of the arrow 9 to the tool 1 is created by the configuration of the (rectilinear) handle 3 which is affixed to the extractor head 2 in a manner such that the angle between-the handle 3 itself and the upper surface of the extractor head 2 is also an obtuse angle.

The use of the tool is quite simple and is well illustrated in its principal phases by the accompanying Figures . . . .

Through the use of a bead breaker tool 14, which acts in the direction of the arrow 15, the tire bead 11 is lifted, that is, displaced (toward the inside of the wheel rim 12) from the annular seating 16 behind the edge 13 in which the bead was originally installed.

The end of the extractor head 2 is easily inserted into the space made beside the bead breaker tool 14.

After having withdrawn the bead breaker tool 14, a rotation of the extractor tool 1 in the direction of the arrow 9 raising the bead 11 is produced by acting upon the handle 3. The “gripping” of the bead by the extractor head 2 is ensured by the particular configuration of the head itself, by virtue of which the opposite reaction of the bead (which comes into contact with the upper surface of the extractor head 2) acts upon the corresponding upper surface of the extension 4 producing a load distribution by virtue of which the fulcrum (point of contact between the back or lower surface of the extractor head with the outer edge 13 of the rim 12) is always located between the power (force applied to the handle 3 by the user) and the resistance (reaction exerted by the tire bead on the extractor head).

Completion of the aforesaid rotation leads to climbing the edge 13 and the subsequent extraction of the bead section involved, which is then located beside the edge 13.

Using the extracted zone, the extraction operation can then be continued through-out the bead.

The invention makes it possible to perform the extraction with a simple maneuver which demands neither a particular physical effort nor particular techniques of the user or care in inserting the tool.

It also permits safe operation.

Obviously, a number of practical/application type modifications of the construction details can be made to the invention without departing from the protective scope of the novel idea as claimed below.

1. An extractor tool, in particular for the extraction of PAV type tire beads, comprising an extractor head (2) affixed in extension to a handle (3) and whose end is shaped as a bent extension (4) having a predetermined inclination relative to the longitudinal axis of the main body of the head (2) so as to generate an upper surface intended to operate in contact with the bead (11) of a tire (10), having a concave surface (5) which joins the said bent extension (4) with the body of the head (2), and also to generate a lower surface, intended to operate in contact with the edge (13) of a tire rim (12) of which a first short section of its end (6) bounds the extension (4) from underneath, and which is connected to a second more extensive section (7) by means of a joint (8) of which the radius of curvature is perceptibly less than the radius of curvature of the concave surface (5).

2. An extractor tool as in claim 1, wherein said bent extension (4) subtends an obtuse angle with the main body of the extractor head (2).

3. A bead breaker tool as in claim 1 or 2, wherein said handle (3) is affixed to said extractor head (2) in a manner such that the angle between the handle (3) itself and said upper surface of the extractor head (2) is an obtuse angle.

4. An extractor tool as in the preceding claims and in accordance with that which is described and illustrated with reference to the accompanying Figures and for the above cited purposes.
